(19) United States
(12) Patent Application Publication
(10) Pub. No.: US 2019/0162411 A1
(43) Pub. Date: May 30, 2019

(54) INTEGRATED GAS IGNITER FOR SOLID FUEL FIRE PIT

(71) Applicant: GHP Group, Inc., Niles, IL (US)

(72) Inventors: Daniel Choi, Niles, IL (US); Nicole Toledo, Niles, IL (US); Wang (Alan) Bin, Niles, IL (US)

(73) Assignee: GHP Group, Inc., Niles, IL (US)

(21) Appl. No.: 16/092,543

(22) PCT Filed: Apr. 14, 2017
(86) PCT No.: PCT/US17/27692

§ 371 Date: Oct. 10, 2018

Related U.S. Application Data
(60) Provisional application No. 62/323,156, filed on Apr. 15, 2016.

(51) Int. Cl. F23Q 13/02; F24B 15/00; F24B 1/192; F24B 3/00; A47J 37/07

(52) U.S. Cl. CPC F23Q 13/02; F24B 15/005; A47J 37/0713; F24B 3/00; A47J 37/0786; F24B 1/192

(57) ABSTRACT

A solid fuel burning fire pit is described. The fire pit includes a bowl with an aperture that receives a burner. A fuel source integrated with the fire pit and in fluidic communication with the burner is used to ignite solid fuel disposed in the bowl of the fire pit. Once the solid fuel is ignited, the fuel source may be turned off by a user, or automatically turn off based on temperature or time thresholds.

### CROSS REFERENCES TO RELATED APPLICATIONS

This application claims the benefit of U.S. Provisional Patent Application Ser. No. 62/323,156, entitled Integrated Gas Igniter for Solid Fuel Fire Pit, filed on Apr. 15, 2016, the content of which is incorporated herein by reference in its entirety.

### FIELD

The present disclosure relates generally to fuel burning units, and more particularly to solid fuel burning units.

### BACKGROUND

Solid fuel burning fire pits provide outdoor heat and pleasant social gathering spotlights. Illustrative solid fuels include, for example, wood and charcoal. One traditional technique for igniting solid fuel includes igniting newspaper (or other paper products) and placing the lit paper on or underneath the solid fuel source. Another traditional ignition technique involves pouring a flammable liquid (e.g., lighter fluid) on the solid fuel source and igniting the flammable liquid. A further traditional ignition technique involves using a hand held torch (e.g., a butane torch) to ignite the solid fuel source.

The aforementioned ignition techniques have several drawbacks. For instance, igniting solid fuel using the above techniques is not always reliable due to various factors such as windy conditions. Moreover, the aforementioned ignition techniques can be dangerous to the user due to the use of flammable or combustible materials. Moreover, regardless of the ignition technique used, ignition of solid fuel using the above techniques can be time consuming.

### SUMMARY

The present disclosure generally relates to a solid fuel burning fire pit that ignites solid fuel reliably and expeditiously. The fire pit includes a bowl with an aperture, and a fuel source integrated within the fire pit and in fluidic communication with the aperture. The fuel source is lit and used to ignite solid fuel within the bowl of the fire pit.

In one example, the solid fuel fire pit includes a bowl adapted to have solid fuel disposed therein and including an aperture, a burner extending into the aperture; and an ignition assembly adapted to use a non-solid fuel source and in fluidic communication with the burner.

The ignition assembly includes a valve assembly coupled to and in fluidic communication with the burner and a thermocouple extending into the burner and coupled to the valve assembly.

In one aspect, the thermocouple may be adapted to actuate the valve assembly to an OFF state based on a temperature threshold. The temperature threshold may correspond to an ignition temperature of a solid fuel.

In another aspect, the thermocouple may be adapted to actuate the valve assembly to an OFF state based on a time threshold. The time threshold may also correspond to an ignition time of the solid fuel.

In this manner, the fire pit provides a quick, easy, and reliable way for a user to ignite solid fuel.

The aspects, advantages, features, and details of the present disclosure will be further understood in consideration of the following detailed description of certain embodiments taken in conjunction with the drawings.

### BRIEF DESCRIPTION OF THE DRAWINGS

Embodiments of devices, systems, and methods are illustrated in the figures of the accompanying drawings, which are meant to be exemplary and non-limiting, in which like references are intended to refer to like or corresponding parts, and in which:

FIG. 1 illustrates a perspective view of a solid fuel fire pit according to the present disclosure.

FIG. 2 illustrates a perspective view of the solid fuel fire pit with a cover removed according to the present disclosure.

FIG. 3 illustrates a perspective view of the solid fuel fire pit with a side panel being removed according to the present disclosure.

FIG. 4 illustrates a perspective view of the solid fuel fire pit with the cover and a cooking grate removed according to the present disclosure.

FIG. 5 illustrates a perspective view of a bowl and a burner assembly of the solid fuel fire pit according to the present disclosure.

FIG. 6 illustrates a perspective view of a bottom of the solid fuel fire pit according to the present disclosure.

FIG. 7A illustrates a perspective view of a regulator assembly of the solid fuel fire pit according to the present disclosure.

FIG. 7B illustrates a perspective view of a valve and burner assembly of the solid fuel fire pit according to the present disclosure.

FIG. 8 illustrates another perspective view of the regulator assembly and valve and burner assembly of the solid fuel fire pit according to the present disclosure.

### DETAILED DESCRIPTION

In the following detailed description, reference is made to the accompanying Figures, which form a part thereof. In the Figures, the same numbers typically identify similar components, unless context dictates otherwise. The illustrative embodiments described in the detailed description and Figures are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein. For instance, while the present disclosure describes a fire pit, it should be understood that the technology can be readily applied to applications in indoor fireplaces, solid fuel burning grills, stoves and other types of “fires.”

The present disclosure generally relates to a solid fuel burning fire pit that ignites solid fuel reliably and expeditiously. The fire pit includes a bowl with an aperture, and a fuel source integrated within the fire pit and in fluidic communication with the aperture. The fuel source is lit and used to ignite solid fuel within the bowl of the fire pit.

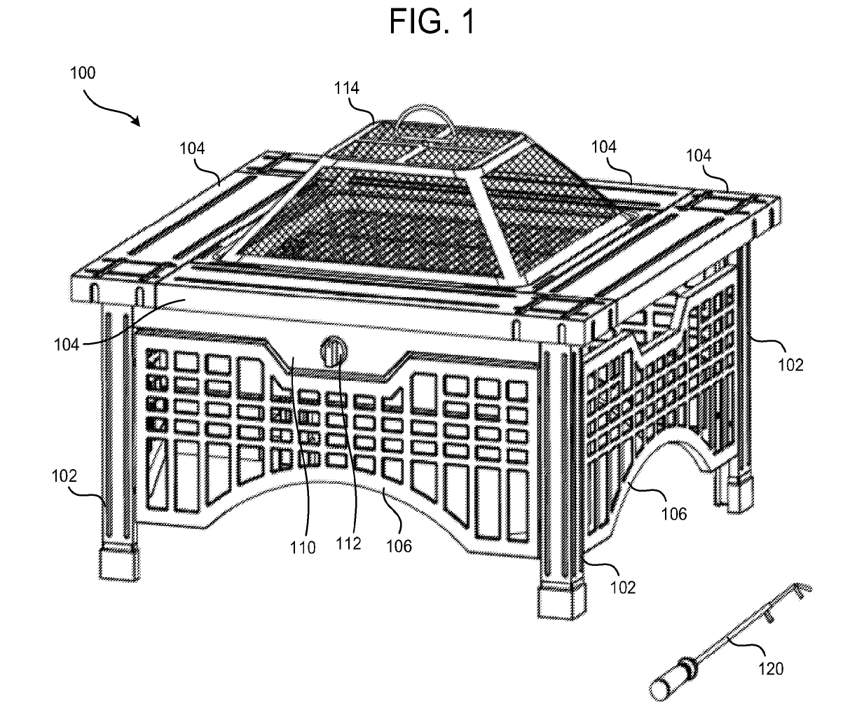

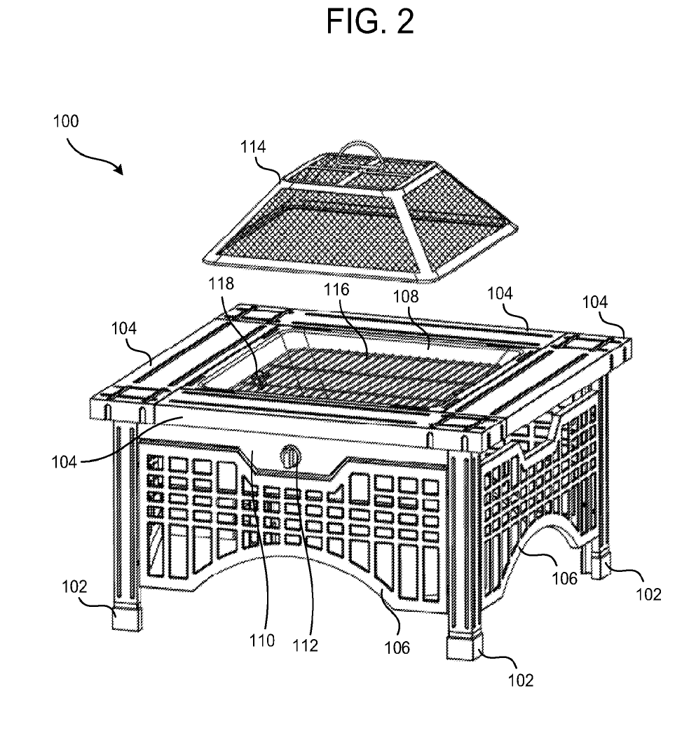

FIGS. 1-4 illustrate a solid fuel burning fire pit 100 with an integrated ignition assembly built into the fire pit 100. The fire pit 100 may include legs 102, table or ledge portions 104, panel sections 106 extending between the legs 102, a bowl 108 supported by the ledge portions 104, and a support 110 that supports the integrated ignition assembly, which includes a knob 112 that can be manipulated by a user. The fire pit 100 may optionally include a cover 114 to reduce emission of particles, such as ash, and to reduce the danger of contact with lit solid fuel. The fire pit 100 may also optionally include a cooking grate 116 that may be disposed on support brackets 118. The fire pit 100 (as described in further detail below) may be a kit that also includes a poker 120 (as illustrated in FIG. 1), a cover, and other accessories.

The legs 102 may couple to ends of the respective ledge portions 104, for example via fasteners, to form a frame with the legs 102 extending vertically and the ledge portions on top of the legs 102. As illustrated, there are four legs 102 and four ledge portions 104, and the fire pit 100 is square. However, the fire pit 100 may include more or less than four legs 102 and ledge portions 104, and the fire pit 100 may have a different shape. The ledge portions 104 may be separate pieces coupled together via fasteners for example, or may be integrated into a single monolithic piece. Similarly, the legs 102 may be separate pieces or integrated with the ledge portions 104 into a single monolithic piece.

The panel sections 106 may be coupled to, for example via fasteners, and extend between the respective legs 102. As with the legs 102 and ledge portions 104, there are four panel sections 106. However, the fire pit 100 may include more or less than four panel sections 106 depending on the shape of the fire pit.

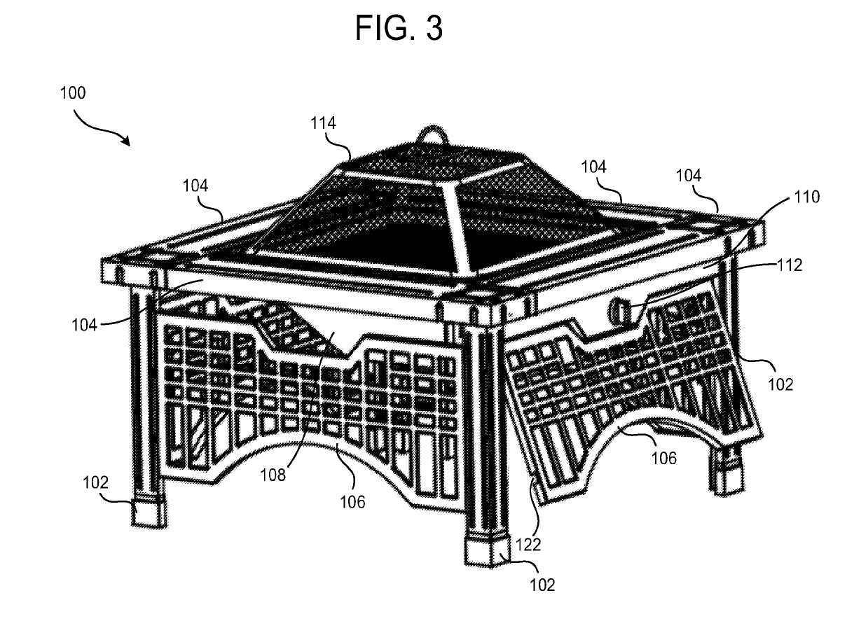

As illustrated in FIG. 3, one or more of the panel sections 106 may be removable by the user to provide access to an underside of the fire pit 100. This allows the user to install or replace a non-solid fuel source, as well as access the integrated ignition assembly. As illustrated, the panel section 106 on a same side of the fire pit 100 as the support 110 includes notches 122 on both sides. The corresponding legs 102 include mating structures that engage the notches 122. This allows the panel 106 to be pulled and removed from the fire pit 100. While the fire pit 100 is illustrated as including female notches 122 on the panel section and corresponding male engaging structures on the legs 102, the legs 102 may include female notches and the panel section 106 may include corresponding male engaging structures.

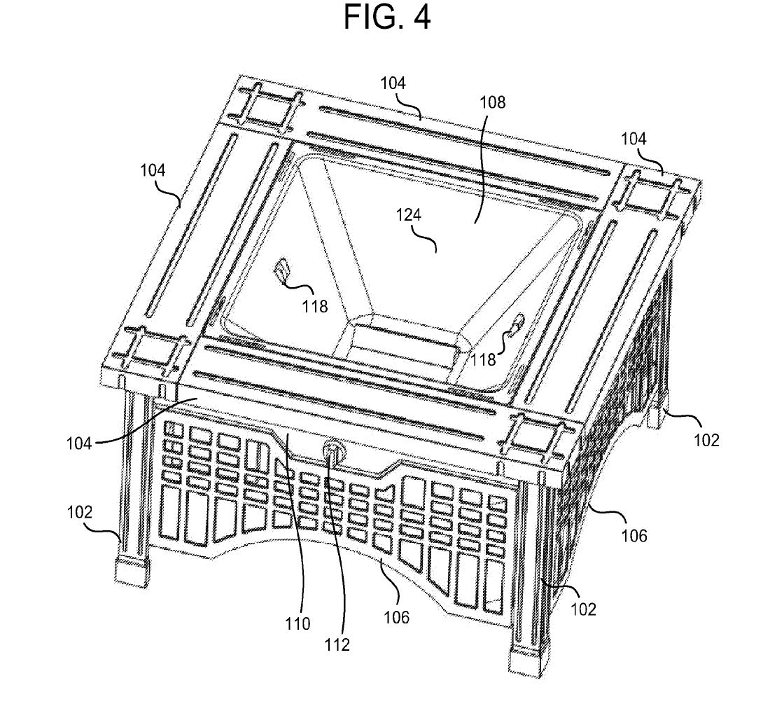

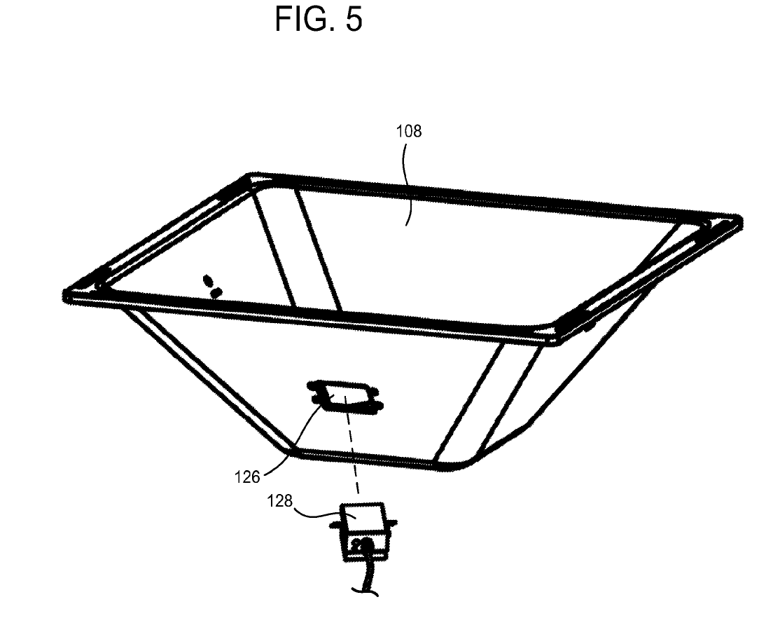

Referring to FIGS. 4 and 5, the bowl 108 is supported by the ledge portions 104. The bowl 108 may rest on inwardly extending support arms of the ledge portions 104, and may be removable from the ledge portions 104 by a user lifting the bowl 108 out of engagement with the support arms. Alternatively, the bowl 180 may be coupled to the ledge portions 104 via fasteners.

One or more vent structures 124 may also be disposed in and/or coupled to the bowl 108 (as illustrated in FIG. 4). These vent structures may be hollow and allow for air circulation around solid fuel disposed in the bowl 108. The bowl 108 may have a shape identical or substantially identical to the shape of the fire pit 100. Alternatively, the bowl 108 may have a shape distinctly different from that of the fire pit 100. For example, the bowl 108 may have a square shape, or another shape depending upon implementation.

Referring to FIG. 5, the bowl 108 may include an aperture 126 into which a gas orifice of a burner 128 may be disposed. As illustrated, the aperture 126 is centrally located in a side of the bowl 108. However, the aperture 126 may be located anywhere along any side of the bowl 108, or a bottom of the bowl 108.

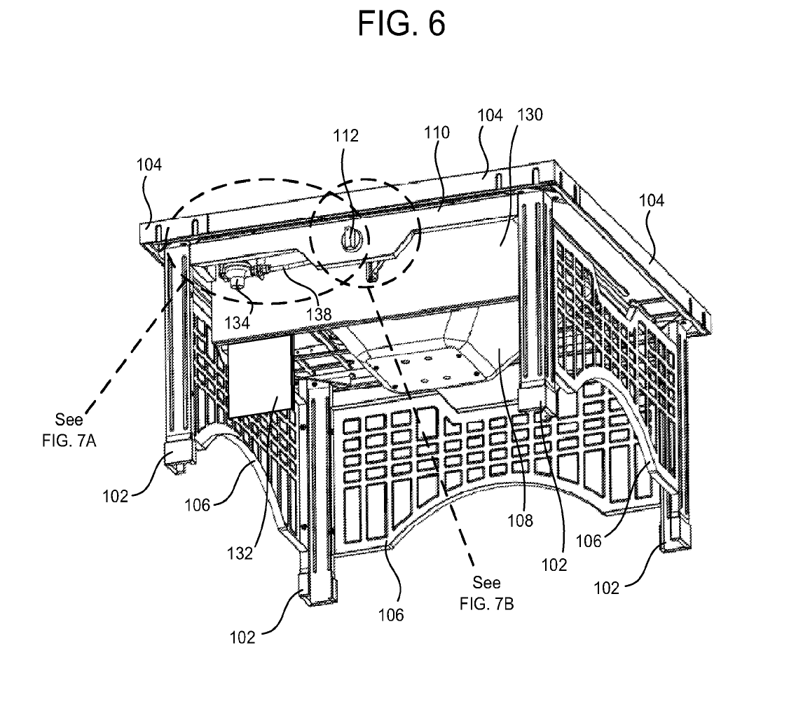

Referring to FIG. 6, which illustrates the fire pit 100 with panel 106 removed, the fire pit 100 may include a first heat shield 130 that extends vertically downward along a side of the fire pit, and between the integrated ignition assembly and the bowl 108. A second heat shield 132 may also be coupled to and extend further vertically downward from the first heat shield 130. The second heat shield 132 may be disposed between a regulator assembly 134 of the integrated ignition assembly (as describe in further detail below) and the bowl 108. The first and second heat shields 130 and 132 may assist in protecting the integrated ignition assembly and fuel tank (which holds a non-solid fuel) from heat dissipated from the bowl 108 when solid fuel is ignited and burned within the bowl 108.

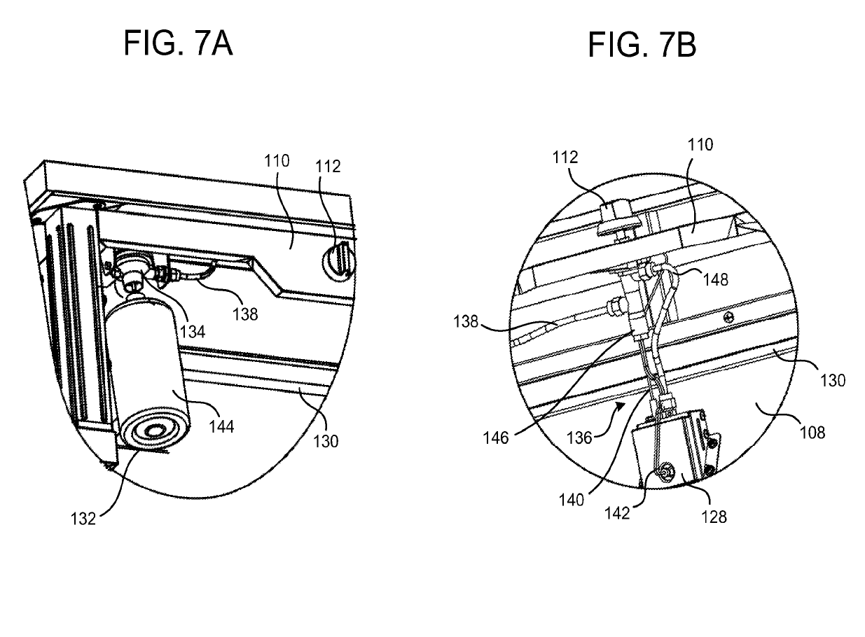

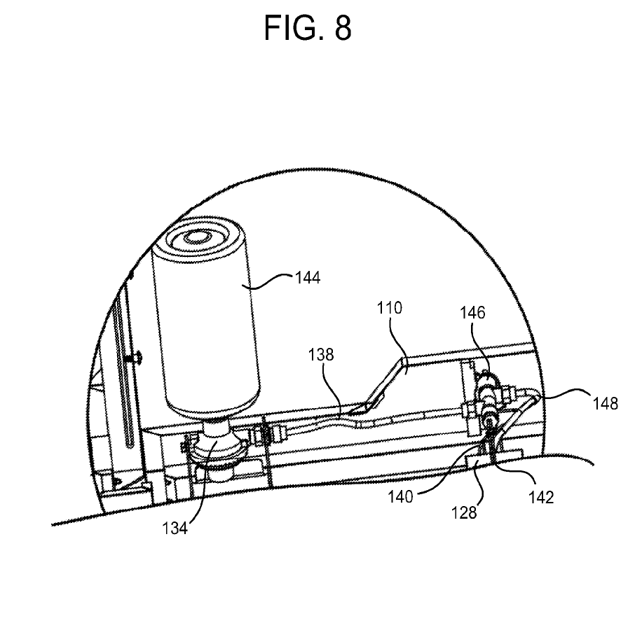

Referring to FIGS. 7A, 7B, and 8, the integrated ignition assembly includes the regulator assembly 134, a valve and burner assembly 136, a pipe 138, a thermocouple 140, an electrode 142, and the knob 112.

The regulator assembly 134 includes a receiving portion that receives a fuel tank 144, and a regulator that regulates release of fuel from the fuel tank. The valve and burner assembly 136 includes the burner 128, a valve assembly 146 (which may be a thermocouple valve), and a fuel pipe 148 that provides fluidic communication of fuel between the valve assembly 146 and the burner 128. The pipe 138 is coupled to the regulator assembly 134 and the valve assembly 146, and provides fluidic communication of fuel between the regulator assembly 134 and the valve assembly 146.

The electrode 142 is coupled to and may extend into the burner 128, and coupled to the valve assembly 146. The electrode 142 provides an electrical ignition source to ignite the fuel from the fuel tank 144 when the knob 112 coupled to the valve assembly 146 is in an ON position (which allows fuel to flow from the fuel tank 144, through the valve assembly 146 and fuel pipe 148, to the burner 128).

The thermocouple 140 is also coupled to and may extend into the burner 128, and coupled to the valve assembly 146. The thermocouple 140 allows the fuel to remain ON and flow through the valve assembly 146 to the burner 128, when the burner is lit or ignited. However, when the burner is not lit, the thermocouple 140 may cause the valve assembly 146 to enter a safety shut-off mode and prevent fuel from flowing to the burner 128. This prevents the fuel from continuing to flow when the burner 128 is not ignited.

The knob 112 is coupled to an end of the valve assembly 146 extending through the support 110 (which may also be referred to as a control panel). The knob 112 may be turned by a user to place the valve assembly 146 in an ON state or an OFF state. When the fuel tank 144 is installed and the regulator assembly 134 allows fuel to flow through the pipe 138 to the valve assembly 146, the knob 112 may be depressed and/or turned by a user to place the valve assembly 146 in an ON state. When in the ON state, the valve assembly 146 allows the fuel to flow from the fuel tank 144, through the valve assembly 146 and fuel pipe 148, to the burner 128. Alternatively, when in the OFF state, the valve assembly 146 prevents the fuel from flowing through the valve assembly 146 and fuel pipe 148 to the burner 128.

The fuel tank 144 may contain one or more types of fuel, such as propane, natural gas, butane, etc. capable of flowing to the burner 128. In one example, the fuel tank 144 may be a 1 lb (i.e., 16.4 oz) propane tank.

During use of the fire pit 100, a user may place solid fuel, such as wood, charcoal, paper, or other burning material, into the bowl 108. To ignite the solid fuel, the user may depress and/or rotate the knob 112 to actuate the valve assembly 146 and place the valve assembly 146 into the ON state. This allows fuel to flow from the fuel tank 144 to the burner 128. Simultaneously therewith or thereafter, the user may depress an electronic igniter switch (which may be actuated when the knob 112 is depressed and/or rotated or may be a separate switch) to cause the electrode 142 to generate a spark that ignites the fuel in the burner 128. A flame may flare out or up (depending on where the burner 128 is located in the bowl 108) into the bowl 108, thereby contacting the solid fuel in the bowl 108. The thermocouple 140 may be configured to maintain the flame, without the user having to hold the valve assembly 146 in the ON state.

In one embodiment, the user may monitor the ignition of the solid fuel. When the solid fuel is sufficiently ignited, the user may manually place the valve assembly 146 into the OFF state using the knob 112.

In other embodiments, the thermocouple 140 may have a temperature and/or time threshold. For example, the temperature threshold may be a temperature (such as between 100° F. and 400° F.) that when achieved, automatically places the valve assembly 146 into the OFF state. In another example, the time threshold may be a time (such as between 30 seconds and 3 minutes) that when achieved, automatically places the valve assembly 146 into the OFF state. These temperature and time thresholds are set to correspond to a temperature and/or time at which sufficient ignition of the solid fuel in the bowl 108 is achieved. Different solid fuels require a different temperature and or amount of time to ignite. That is, solid fuels have unique ignition points/temperatures. As such, it should be appreciated that the temperature and/or time thresholds are configured based on the type of solid fuel being ignited.

The fire pit 100 described herein therefore provides a quick, easy, and reliable way for a user to ignite solid fuel.

Although the devices, systems, and methods have been described and illustrated in connection with certain embodiments, many variations and modifications will be recognized by those skilled in the art and may be made without departing from the spirit and scope of the disclosure. The discourse is thus not to be limited to the precise details of methodology or construction set forth above as such variations and modification are intended to be included within the scope of the disclosure.

What is claimed is:

1. A solid fuel fire pit, comprising:
a bowl adapted to have solid fuel disposed therein and including an aperture;
a burner extending into the aperture; and
an ignition assembly adapted to use a non-solid fuel source and in fluidic communication with the burner.

2. The fire pit of claim 1, wherein the ignition assembly includes a regulator coupled to and in fluidic communication with the burner.

3. The fire pit of claim 2, further comprising the non-solid fuel source in fluidic communication with the regulator.

4. The fire pit of claim 2, wherein the ignition assembly includes a valve assembly including a valve coupled to and in fluidic communication with the regulator and the burner.

5. The fire pit of claim 1, wherein the ignition assembly includes:
a valve assembly coupled to and in fluidic communication with the burner; and
a thermocouple extending into the burner and coupled to the valve assembly.

6. The fire pit of claim 5, wherein the thermocouple is adapted to actuate the valve assembly to an OFF state based on a temperature threshold.

7. The fire pit of claim 6, wherein the temperature threshold corresponds to an ignition temperature of a solid fuel.

8. The fire pit of claim 5, wherein the thermocouple is adapted to actuate the valve assembly to an OFF state based on a time threshold.

9. The fire pit of claim 8, wherein the time threshold corresponds to an ignition time of a solid fuel.

10. The fire pit of claim 1, further comprising a side panel adapted to be removed and allow access to the ignition assembly.

11. The fire pit of claim 1, further comprising a knob coupled to the ignition assembly and adapted to be manually manipulated by a user to place the ignition assembly in an ON state or an OFF state.
